(19) United States
(12) Patent Application Publication
(10) Pub. No.: US 2010/0149319 A1
(43) Pub. Date: Jun. 17, 2010

(54) SYSTEM FOR PROJECTING THREE-DIMENSIONAL IMAGES ONTO A TWO-DIMENSIONAL SCREEN AND CORRESPONDING METHOD

(75) Inventors: Nicolas Filliard, Paris (FR); Gilles Reymond, Chevreuse (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: RENAULT S.A.S., Boulogne-Billancourt (FR)

(21) Appl. No.: 12/530,326

(22) PCT Filed: Mar. 4, 2008
(86) PCT No.: PCT/FR2008/050367

§ 371 Date: Feb. 19, 2010

(30) Foreign Application Priority Data
Mar. 9, 2007 (FR) 0753747

(51) Int. Cl. H04N 13/04

(52) U.S. Cl. 348/51; 348/744; 348/E13.075

(57) ABSTRACT

A method and system for projecting three-dimensional images on a two-dimensional screen that includes a static correction module for each image capable of deforming the image before the projection thereof depending on the screen configuration and relative to a fixed reference point. The system further includes a sensor capable of detecting in real time the position of a selected observer watching the screen, and a dynamic correction module coupled upstream from the static correction module and capable of automatically correcting in real time distortion generated on each image by movement of the observer relative to the reference point based on the observer's position, on the reference point position, and on the screen configuration.

The present invention relates generally to the projection of three-dimensional synthetic images onto a two-dimensional screen. These projection systems are used in particular in simulation systems (for example, driving simulation systems) and virtual reality systems.

In practice, the simulation and virtual reality systems use panoramic projection screens to display the three-dimensional synthetic images computed by the computer. In order to increase the field of vision available to the user while minimizing the eye-screen distance variations, curved screens are preferably used.

Projection onto a curved screen necessarily produces a geometrical deformation of the images. However, this deformation can easily be compensated by performing an inverse deformation using a static distortion correction module. In this way, the observer can watch scenes in three dimensions with a correct perspective.

However, the current systems for projecting onto a curved screen are designed for a single point of view. In other words, each movement of the observer leads to a distortion of the image that he is watching. This distortion is distinct from that generated by the curvature of the screen.

Now, many applications require the observer to move.

The known projection systems use hardware or software means which perform an inverse deformation of the image so as to compensate the distortion produced by the curved screens (static distortion correction mentioned hereinabove). These hardware or software means are parameterized beforehand by an operator, according to the geometrical configuration of the projection system (optical characteristics of the projector(s) and geometrical configuration of the screen).

However, the solution commonly employed to avoid the distortions due to the movements of the observer is to limit the displacements of the latter about a point for which the projection system has been calibrated.

Alternatively, it is also possible to perform image correction computations for the distortion associated with the movements of the observer, at the level of the three-dimensional synthetic image generator. However, this solution requires a very comprehensive knowledge of the geometrical configuration of the projection system, which is not always available in practice. Furthermore, this solution is relatively costly in terms of computation time.

More specifically, the document US 2006/00 77 355 discloses a means of correcting the distortion for systems using a plurality of projectors. This means makes it possible to obtain a continuous image on the screen without suffering the distortions due to the shape of that screen. However, there is no provision for any real-time updating of the correction parameters.

The document US 2005/01 40 575 describes a device for correcting the distortion generated by the projection of the images onto a curved screen. This document proposes a method for very rapidly producing an inverse deformation of an image by computations that are simple and inexpensive in terms of computation time, in order to display them correctly on the curved screen. However, the parameters of the deformation are static. They require the intervention of an operator in order to adjust them for another configuration. Consequently, the device described in this document cannot in any way be used to apply a deformation dependent on the point of view of the observer.

The document US 47 14 428 discloses a device for correcting the distortions by applying an inverse deformation to the image that is to be displayed by a projector. However, the proposed device is relatively complex since it requires a good knowledge of the correlation between the image processed by the projector and the image actually displayed on the screen. Furthermore, the correction device proposed by this document corrects the images using a single module which handles all of the correction, that is, both the correction of the “static” deformation and the correction associated with the “dynamic” deformation. The device proposed by this document is therefore relatively complex and inflexible.

The document US 544 68 34 describes a method used to display three-dimensional virtual images on CRT-type screens by respecting the point of view of a selected observer. This method requires a complete and mathematical modeling of the distortion caused by the display of the images onto such screens (distortions due to the curvature and to the optical properties of the screens). This modeling implies a relatively complex method.

The document JP 2004/35 69 89 discloses a system for geometrically correcting an input signal, to take account of the geometrical configuration of non-flat screens. However, this system cannot in any way be used to correct the distortions generated by the displacement of the observer.

The invention aims to provide a solution to these problems.

One aim of the invention is to propose a system for projecting three-dimensional images onto a two-dimensional screen while correcting, simply, in real time and without the intervention of an operator, the distortions of the image generated by the geometrical configuration of the screen (static correction) and the displacement of the observer in front of the screen (dynamic correction).

To this end, according to a first aspect of the invention, there is proposed a system for projecting three-dimensional images onto a two-dimensional screen, comprising a static correction module for each image, able to deform the image before its projection, according to the configuration of the screen and relative to a fixed reference point.

According to the general characteristic of this aspect of the invention, said system also comprises:
a sensor able to detect in real time the position of a selected observer watching the screen, and
a dynamic correction module coupled upstream of the static correction module and able to correct automatically and in real time the distortion created on each image by the movement of the observer relative to said reference point, based on said position of the observer, on the position of the reference point and on the configuration of the screen.

In other words, the image projection system according to the invention comprises, in addition to a static correction module, a dynamic correction module that can correct the additional distortion generated by the movement of the observer in front of the screen.

This module is distinct from the static correction module. This module is designed to operate in real time and independently of any intervention on the part of an operator.

The notable benefit of the invention is to have a relatively simple operation, in particular thanks to the fact that the dynamic correction module is capable of correcting the distortion of the image created by the movement of the observer simply on the basis of the position of the observer, the position of the point of reference and the configuration of the screen.

Furthermore, the invention has the advantage of no longer requiring the intervention of an operator during projection. In practice, the parameters that have to be set are those of the static correction module, the latter being set once for all before starting up the image projection system.

Preferably, said screen is curved. More particularly, the screen can be cylindrical, tapered, spherical, toroidal. It can have the form of any type of surface for which there is an analytical description (continuous or sampled).

According to an embodiment, the projection system can also comprise an image generator comprising a computation module able to compute a flat image according to a predefined configuration, on which each point of the image to be projected is placed according to its real position in space.

Moreover, said dynamic correction module can comprise: a determination means able to determine, for each point of the computed flat image, another point also situated on the flat image, such that the projection of the point concerned of the flat image on the screen relative to the reference point, and the projection of the other corresponding point on the screen relative to said position of the observer, coincide, and a substitution means able to replace each point of the flat image with the other corresponding point.

According to an embodiment, the dynamic correction module is coupled between the image generator and the static correction module.

According to another aspect of the invention, there is proposed a driving simulation appliance comprising a system for projecting three-dimensional images onto a two-dimensional screen, as described hereinabove.

According to another aspect of the invention, there is proposed a method of projecting three-dimensional images onto a two-dimensional screen comprising a “static” correction step in which each image is deformed before its projection, according to the configuration of the screen, and relative to a reference point.

Said method also comprises,

a step for detecting in real time the position of a selected observer watching the screen, and

a “dynamic” correction step in which the distortion created on each image by the movement of the observer relative to said reference point is corrected, based on said position of the observer, on the position of the reference point and on the configuration of the screen.

Preferably, according to one embodiment, the screen is curved.

According to an implementation, the method can include an image generation step in which a flat image is computed, on which each point of the image to be projected is placed according to its real position in space, and in which the “dynamic” correction step can comprise a determination, for each point of the computed flat image, of another point also situated on the flat image, such that the projection of the point concerned of the flat image onto the screen relative to the reference point, and the projection of the other corresponding point onto the screen relative to said position of the observer, coincide, and

a substitution of each point of the flat image with the other corresponding point.

According to an implementation, the “dynamic” correction step can be carried out after the image generation step and before the “static” correction step.

Other benefits and features of the invention will become apparent from studying the detailed description of an embodiment of the invention, and of an implementation, which are by no means limiting, and the appended drawings in which:

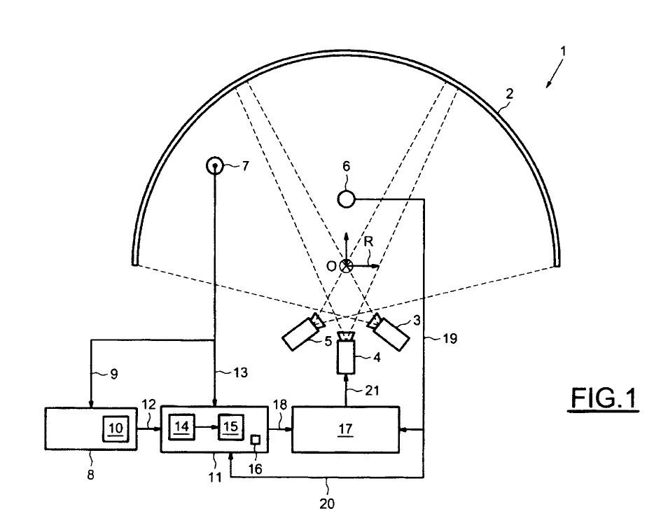

FIG. 1 diagrammatically illustrates a system for projecting three-dimensional images onto a screen according to the invention;

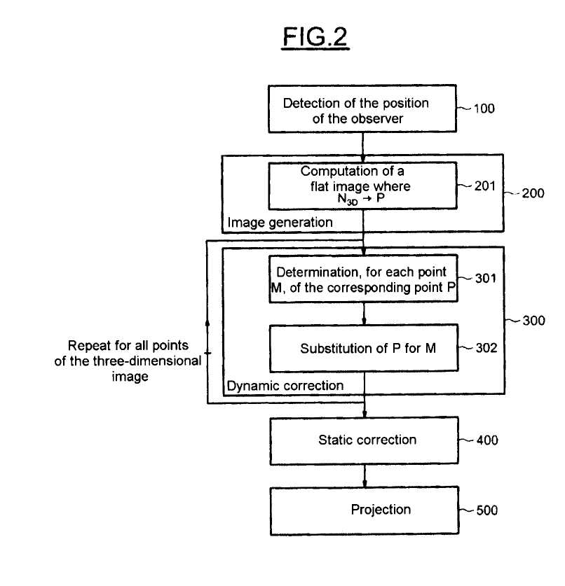

FIG. 2 represents a method of implementing the projection method according to the invention; and

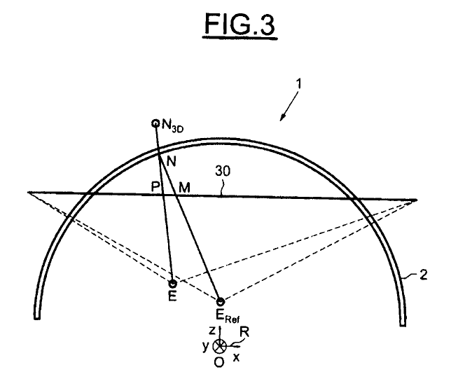

FIG. 3 represents the different points computed at the moment of projection of the three-dimensional images onto a curved screen.

FIG. 1 very diagrammatically represents a system for projecting three-dimensional images 1, onto a screen 2. In this example, the screen 2 is of cylindrical shape. The image is projected onto the surface of the screen. However, the invention is in no way limited to cylindrical-type projection screens.

In effect, the latter can be of spherical, tapered, toroidal type or in the form of any type of surface for which there is an analytical description (continuous or sampled) available.

The projection system also comprises video projectors, in this case three, referenced 3, 4 and 5.

The projectors 3, 4 and 5 can be of any type and arranged generally so as to form a composite image covering the screen 2.

A single video projector can be used.

An observer is placed in front of the screen, the position of the latter is generally determined from the position of his head and more particularly from the position of his eyes.

To this end, a three-dimensional position sensor referenced 7 is used to detect the position of the observer.

More specifically in this example, the sensor 7 makes it possible to fix the position in three dimensions of the eye of the observer, in order to dynamically update the point of view concerned for the display of the image in three dimensions. The position of the eye is given relative to a fixed reference point R.

The position determined by the sensor is transmitted to an image generator 8 via a connection 9.

The image generator 8 generates, according to the position of the eye of the observer, three-dimensional images which will be displayed on the screen 2. For this, the image generator 8 comprises a computation module 10, the function of which will be explained in more detail hereinbelow.

The image generated by the image generator 8 is transmitted to a dynamic correction module 11, via a connection 12.

The dynamic correction module 11 also receives, via a connection 13, the three-dimensional position of the eye of the observer delivered by the sensor 7.

The main function of the dynamic correction module 11 is to deform the image generated by the image generator 8, so as to compensate the movement of the observer relative to a given static calibration point, referenced 6. This deformation can be applied using a so-called “pixel shading” technique, commonly available in current graphics cards. The main steps of this technique will be detailed hereinbelow.

More specifically, the dynamic correction module comprises a determination means 14 and a substitution means 15, the functions of which will be explained in more detail hereinbelow.

Moreover, the dynamic correction module 11 comprises a memory 16 able to memorize the configuration of the curved screen 2.

The image deformed by the dynamic correction module 11 is then transmitted to a static correction module 17 via a connection 18.

The static correction module 17 performs an additional deformation of the image, so as to compensate the distortions generated by the configuration of the curved screen 2 and by the optical characteristics of the projectors 3, 4 and 5.

More specifically, the static distortion correction module 17 performs a deformation of a projected image so as to provide a correct perspective view for a given point of view, referenced 6, generally chosen to be at the centre of the screen (this position is transmitted via a connection 19). This point of view is also used by the dynamic distortion correction module 11 mentioned hereinabove. This reference point is then transmitted to the module 11 via a connection 20.

The static correction module 17 is set by an operator prior to projection. The settings are made once for all and require no additional intervention on the part of the operator during the projection. The dynamic correction module 11 works automatically, in real time according to the position of the eye of the observer.

Finally, the static correction module is coupled to the projectors 3, 4 and 5 via a connection 21, so as to transmit to them the image to be projected.

Referring now to FIG. 2, this figure describes more specifically the algorithm implemented by the image generator 8, the dynamic correction module 11 and the static correction module 17.

First of all, the position of the observer is detected, in particular the position of his eye, 100. Then, depending on this position, the three-dimensional synthetic image that will be displayed on the screen 200 is generated.

The image generation 200 notably comprises the computation of a flat image 201. The computation 201 is carried out by the computation module referenced 10 in FIG. 1.

More specifically, each point of the three-dimensional synthetic image to be displayed is replaced in a flat image computed by the computation module of the image generator.

The flat image 30 is represented in FIG. 3. The position of the flat image 30 is predefined by an operator within the computation module 10.

FIG. 3 shows a point N_{3D} of a three-dimensional synthetic image, as if the latter were actually represented in space.

A point P corresponds to the point N_{3D}, once the latter has been represented in a two-dimensional plane, in this case the flat image 30.

Referring once again to FIG. 2, a dynamic correction 300 is performed on the level of this flat image.

The dynamic correction 300 is performed by the dynamic correction module 11 of FIG. 1.

The dynamic correction step notably comprises a step for determining, for each point M of the flat image 30, another point P.

More specifically, the dynamic correction step 300 includes a determination 301, for each point M of the computed flat image, of another point P also situated on the flat image 30, such that the projection of the point M concerned onto the screen 2, relative to the reference point E_{Ref} (reference position of the observer), and the projection of the other corresponding point P onto the screen 2 relative to said position of the observer E (three-dimensional position determined by the sensor 7), coincide.

This operation for determining the point P relative to a given point M is very easily carried out by the “pixel shading” technique mentioned hereinabove.

The points mentioned hereinabove are illustrated in FIG. 3.

The point N represented on the screen 2 corresponds to the common projection of the point M and of the other point P onto the screen 2 respectively according to the reference position of the observer E_{Ref} and the determined position of the observer E.

We will now refer again to FIG. 2.

Once the other point P is determined, it is substituted for the corresponding point M 302. The substitution step 302 is performed by the substitution means 15 of FIG. 1.

The dynamic correction step 300 is repeated for all the points of the three-dimensional synthetic image.

Then, a static correction 400 is carried out on the image in which the point M has been replaced by the point P.

Once the static correction 400 is carried out, the image is actually projected 500 onto the screen.

The image of the point N_{3D} on the screen 2, seen from the position E of the observer, is the point N.

The projection system can be used in driving simulators, a virtual world animation appliance, or even a CAD data immersive visualization appliance.

It can also be used for the projection of images onto curved surfaces that are translucent (for example by back-projection) or reflective (for example onto semi-reflecting glazed surfaces).

1-10. (canceled)

11. A system for projecting three-dimensional images onto a two-dimensional screen, comprising:
a static correction module for each image, to deform the image before its projection, according to a configuration of the screen and relative to a fixed reference point;
a sensor to detect in real time a position of a selected observer watching the screen; and
a dynamic correction module coupled upstream of the static correction module and to correct automatically and in real time distortion created on each image by movement of the observer relative to the reference point, based on the position of the observer, on a position of the reference point, and on the configuration of the screen.

12. The system as claimed in claim 11, in which the screen is curved.

13. The projection system as claimed in claim 11, further comprising:
an image generator comprising a computation module to compute a flat image according to a predefined configuration, on which each point of the image to be projected is placed according to its real position in space, and
in which the dynamic correction module comprises:
determination means for determining, for each point of the computed flat image, another point also situated on the flat image, such that the projection of the point concerned of the flat image on the screen relative to the reference point, and the projection of the other corresponding point on the screen relative to the position of the observer, coincide, and
substitution means for replacing each point of the flat image with the other corresponding point.

14. The projection system as claimed in claim 13, in which the dynamic correction module is coupled between the image generator and the static correction module.

15. A driving simulation appliance comprising:
a system for projecting three-dimensional images onto a two-dimensional screen, as claimed in claim 11.

16. A method of projecting three-dimensional images onto a two-dimensional screen, comprising:
a static correction in which each image is deformed before its projection, according to a configuration of the screen and relative to a reference point;
detecting in real time a position of a selected observer watching the screen; and
a dynamic correction in which distortion created on each image by movement of the observer relative to the reference point is corrected, based on the position of the observer, on a position of the reference point, and on the configuration of the screen.

17. The method as claimed in claim 16, in which the screen is curved.

18. The method as claimed in claim 16, further comprising:
an image generation in which a flat image is computed, on which each point of the image to be projected is placed according to its real position in space, and
in which the dynamic correction comprises:
a determination, for each point of the computed flat image, of another point also situated on the flat image, such that the projection of the point concerned of the flat image onto the screen relative to the reference point, and projection of the other corresponding point onto the screen relative to the position of the observer, coincide, and
a substitution of each point of the flat image with the other corresponding point.

19. The method as claimed in claim 18, in which the dynamic correction is carried out after the image generation and before the static correction.
